(19) United States
(12) Patent Application Publication
(10) Pub. No.: US 2012/0179277 A1
(43) Pub. Date: Jul. 12, 2012

(54) ATHLETIC RANKING SYSTEM

(76) Inventor: Anthony Lymberopoulos, Houston, TX (US)

(21) Appl. No.: 13/004,742

(22) Filed: Jan. 11, 2011

(51) Int. Cl. G06F 19/00

(52) U.S. Cl. 700/91; 707/E17.014

(57) ABSTRACT

An athletic performance testing system comprises a controlled athletic performance testing environment, a host server for receiving athletic performance test data obtained using the controlled environment, and a website for displaying the athletic performance test data. The website includes a web page for displaying the rankings of the athletic performance test data. A method of ranking athletic performance test data comprises obtaining information about an athlete; setting up a controlled athletic performance testing environment; recording the athletic performance of the athlete performing under the controlled athletic performance testing environment; inputting the athletic performance test results of the athlete into a host server; and displaying and/or causing the athletic performance test results to be displayed on a website that automatically ranks the athletic performance test results.

### BACKGROUND OF THE INVENTION

1. Field of the Invention

Embodiments of the invention generally relate to an athletic performance testing and ranking system and method of use.

2. Description of the Related Art

People of all ages participate in a variety of different sports across the world. A common goal of an athlete is to achieve the highest ranking within a particular athletic event or competition. Time is used generally as a measure of indication of an athlete's performance. Therefore, athletes strive to improve their performance times when performing a specific athletic performance test.

However, time as a performance indicator across the board becomes less reliable due to a number of factors that can affect an athlete's performance when performing an athletic performance test. For example, an athlete running a 40-yard dash on grass may not necessarily have the same performance time when running on turf. Other factors such as course type, weather conditions, equipment restrictions, etc., may all affect the measured time of a performance. Different “time keepers” and time-measuring systems further compound the problem of inaccurate time measurements.

Additionally, only a select few of the vast majority of athletes enjoy the benefit of attending and performing at a handful of standard performance testing events for different sports. And not only are these standard performance testing events generally restricted to a certain geographical area, they are also usually only held a couple of times a year. Thus, an athlete who is injured or may have a bad performance that day has to wait a long period of time before their next opportunity to showcase their abilities.

Finally, once the performance measurements of athletes have been gathered, any useful compilation and/or access to such data has been limited. Athletes in a sport may not ever really know how they compare to athletes from other parts of the country or even the world that have not participated in the exact same performance test. Nor would they know how they compare to athletes who simply do not have the means to attend a particular school or have access to sporting recruiters and coaches. Conversely, such sporting recruiters and coaches will potentially overlook or never see a large talent pool of athletes due to the lack of communication.

Therefore, there is a need for a standard athletic performance testing system that is portable and accessible to all athletes for measuring and certifying the performance results of athletes. There is also a need for a standard athletic performance ranking system that is certifiable and accessible to all athletes for comparing and sharing their athletic performance data to other athletes, recruiters, coaches, and individuals all over the world.

### SUMMARY OF THE INVENTION

In one embodiment, an athletic performance testing system may comprise a controlled athletic performance testing environment including a portable turf, a sensing device, a recording device, and a display device. The system may further include a host server for receiving athletic performance test data obtained using the controlled environment. The system may further include a website for displaying the athletic performance test data, and that has a web page for displaying the rankings of the athletic performance test data.

In one embodiment, a method of ranking athletic performance test data comprises obtaining information about an athlete; setting up a controlled athletic performance testing environment; verifying that the controlled athletic performance testing environment is in accordance with a certified testing standard; recording the athletic performance of the athlete performing under the controlled athletic performance testing environment; inputting the athlete information and athletic performance test results of the athlete into a host server; and displaying the athletic performance test results on a website, wherein athletes are automatically ranked according to their athletic performance test results under the controlled athletic performance testing environment.

In one embodiment, a method of ranking athletic performance test data comprises obtaining information about an athlete; setting up a controlled athletic performance testing environment; verifying that the controlled athletic performance testing environment is in accordance with a certified testing standard; recording the athletic performance of the athlete performing under the controlled athletic performance testing environment; inputting the athlete information and athletic performance test results of the athlete into a host server; and causing the athletic performance test results to be displayed on a website, wherein athletes are automatically ranked according to their athletic performance test results under the controlled athletic performance testing environment.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a controlled athletic performance testing environment according to one embodiment.

FIG. 2 illustrates a schematic view of an athletic performance testing system according to one embodiment.

FIG. 3 illustrates a flow diagram of a method of using the athletic performance testing system according to one embodiment.

FIG. 4 illustrates a schematic view of a first web page of the athletic performance testing system according to one embodiment.

FIG. 5 illustrates a schematic view of a second web page of the athletic performance testing system according to one embodiment.

FIG. 6 illustrates a schematic view of a third web page of the athletic performance testing system according to one embodiment.

### DETAILED DESCRIPTION

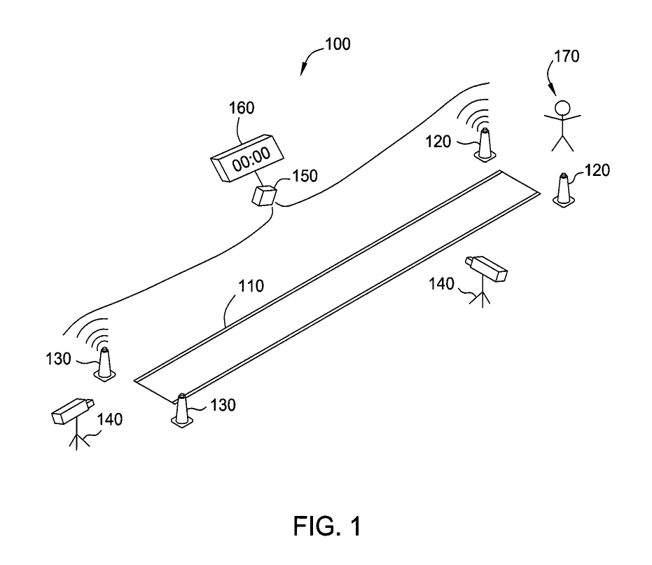

FIG. 1 illustrates a controlled environment 100 for performing an athletic performance test according to one embodiment. The controlled environment 100 includes a portable surface 110, one or more sensors 120, 130, one or more recording devices 140, a controller 150, and a time display device 160. The controlled environment 100 is arranged to record, verify, and certify the performance of an athlete 170 conducting an athletic performance test. The controlled environment 100 can be set up at one or more locations so that athletes can perform the exact same athletic performance test around the world under the exact same conditions. The controlled environment 100 provides a standardized athletic performance testing system that can be replicated at various facilities to allow an athlete in one part of the world to take the exact same athletic performance test as another athlete in another part of the world. In this manner, the performance data of all athletes can be generated and compiled into a uniform ranking system to compare and rank athletes from all over the world under a standard performance testing system, thereby eliminating the inaccuracies of performance tests and data caused by variations in course type, condition, equipment, etc. used for measuring the same athlete performance test.

In one embodiment, the sensors 120, 130 are placed at the start and the finish of the portable surface 110, the length of which may be tailored to a specific athletic performance test, such as a 20-yard dash, 40-yard dash, 50-yard dash, 100-yard dash, or other similar running performance test. The sensors 120, 130 are in communication with the controller 150 via wired or wireless communication. The controller 150 activates and deactivates the timer within the timing display device 160.

When the athlete 170 passes the sensors 120, a signal is sent to the controller to start the timer, and when the athlete 170 passes the sensors 130, a signal is sent to the controller to stop the timer. The time for the athlete 170 to complete the performance test is recorded and displayed by the timing display device 160. While the athlete 170 is performing the performance test, the recording devices 140 are recording the athlete's performance, as well as the timing display device 160. The athlete's performance time and other personal information (photo, height, weight, age, school, etc.) about the athlete can be verified and recorded.

In one embodiment, the portable surface 110 may include an artificial surface that can be moved as desired to set-up the controlled environment 100 at various locations. In one embodiment, the portable surface 100 may include artificial turf. In one embodiment, the portable surface 100 may include grass. Other types of surfaces for performing athletic performance tests may be used.

In one embodiment, the sensors 120, 130 may include laser-switch type sensors that automatically trigger the controller 150 to activate and deactivate the timer upon the athlete 170 passing a threshold or light barrier formed by the sensors 120, 130. The sensors 120, 130 may also be portable and easily moved to accommodate numerous athletic performance tests that are performed with the controlled environment 100. In one embodiment, the sensors 120, 130 may include a speed measuring device, such as a radar gun, or vertical jump measuring device for measuring how high an athlete can jump from a stationary position. Other types of sensors for accurately triggering the controller 150 and the timer may be used.

In one embodiment, the recording devices 140 may include cameras, video cameras, and/or other audio/visual recording devices. The recording devices 140 may be used to record the athletic performance of the athlete 170, as well as the timing display device 160 to accurately verify and certify the athlete's performance. Other types of recording devices for accurately recording the athletic performances of athletes may be used.

In one embodiment, a controlled environment 100 may be arranged for a variety of different athletic performance tests, including but not limited to running, jumping, throwing, lifting, etc. In one embodiment, a controlled environment 100 may be arranged for one or more athletic performance tests of a specific sport, including but not limited to football, baseball, basketball, soccer, track and field, etc. In one embodiment, a controlled environment 100 may be arranged to measure one or more athletic performance metrics, including but not limited to timing, speed, endurance, agility, strength, power, vertical jump, etc.

In one embodiment, a controlled environment 100 may include a portable surface 110, such as a pitching mound, a sensor 120, such as a radar gun, a recording device 140, such as a video camera, and a display device 160 for displaying the measurement of the sensor 120, such as the speed of a baseball or softball thrown by an athlete into a catching net and measured with the radar gun. In one embodiment, the recording device may record an athlete standing on the portable turf and throwing a baseball or softball a certain distance into the catching net. Another recording device may record the throwing speed measured by the sensor. The performance results may thereby be certified and verified by the use of the controlled environment and the video recording evidence of the athletic performance.

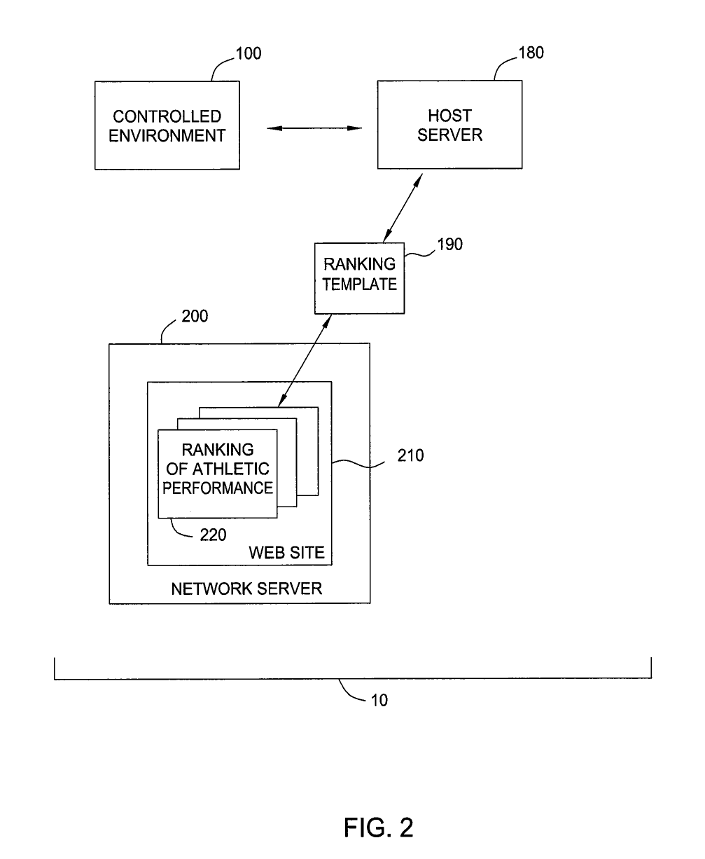

FIG. 2 illustrates a schematic view of an athletic performance testing system 10 according to one embodiment. The athletic performance testing system 10 includes the controlled environment 100, a host server 180, a ranking template 190, a network server 200, an athletic performance website 210, and one or more web pages 220. As stated above, the controlled environment 100 is used to capture and certify the athletic performance data of athletes, such as the performance times and athlete personal information, under standardized testing conditions.

The athletic performance data may be input into the host server 180 by a primary operator using one or more communication methods, including wired and/or wireless communication systems. The primary operator may include an individual who has sole control and access to the information that is input into the host server 180. The primary operator may ensure that the performance data was captured using the controlled environment 100 performance test conditions.

Once the athletic performance data is input into the host server 180, the data is automatically entered into the ranking template 190 to generate and post one or more web pages 220 on the athletic performance website 210, which is supported on the network server 200. Individuals may then access the athletic performance website 210 on-line via the internet or other similar source to view the athletic performance data, including overall rankings of all the athletes who performed an athletic performance test under the controlled environment 100 performance test conditions.

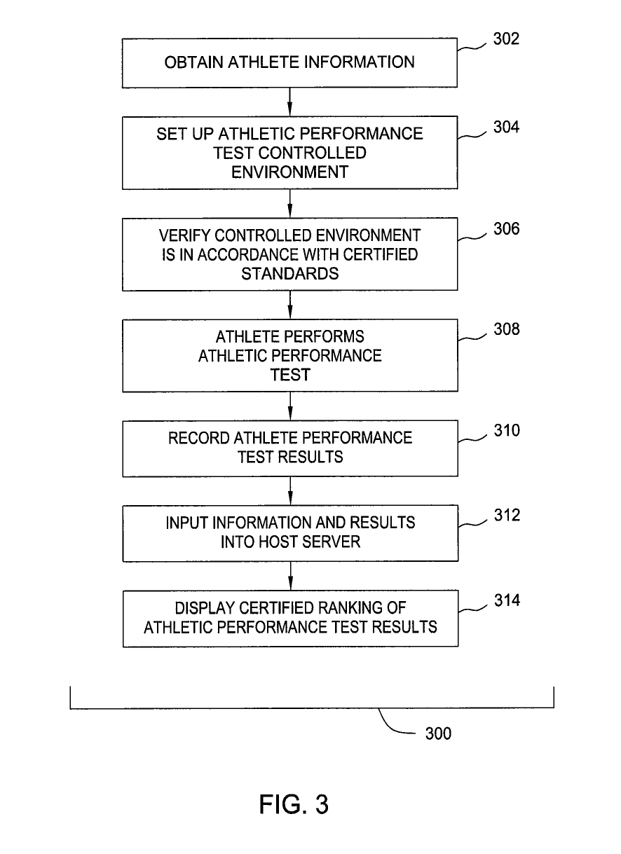

FIG. 3 illustrates a flow diagram of method steps 300 of using the athletic performance testing system 10, according to one embodiment, to collect, certify, and display athletic performance data from athletes performing athletic performance tests. One or more of the method steps 300 may be repeated and/or performed in a different order than illustrated in FIG. 3. As illustrated, a first step 302 may include obtaining the athlete's personal information, such as name, age, gender, weight, height, photo(s), school(s), sport(s), position(s), graduation date(s), team(s), and/or any other identifying/contact information necessary to communication with the athlete. In one embodiment, the athlete may fill out an application by paper or electronically (on-line) to obtain the information. In one embodiment, the information may be obtained prior to or when the athlete arrives at a facility where the controlled environment 100 is located.

A second step 304 may include setting up the controlled environment 100 for a specific athletic performance test that will be performed. This second step 304 may include preparing the portable surface 110, arranging the sensing and recording devices 120, 130, 140, and/or arranging the controller 150 and time displaying device 160. A third step 306 may include verifying that the controlled environment 100 is set up in accordance with one or more certified standards. In one embodiment, the portable surface 110 may be tested to ensure that it is in the proper condition for the athletic performance test. In one embodiment, the sensing devices 120, 130, the recording devices 140, the controller 150, and/or the time displaying devices 160 may be tested to ensure that they are in proper working condition, have had proper maintenance, and/or are similar to the devices that are used for the same performance tests at other controlled environment 100 arrangements.

A fourth step 308 may include the athlete performing the athletic performance test under the controlled environment 100 performance test conditions. In one embodiment, the athletic performance test may include any type of test that measures a specific athletic ability known by one of ordinary skill in the sports industry, such as running, jumping, throwing, lifting, etc. In one embodiment, the athletic performance test may include the 20-yard dash, 40-yard dash, 50-yard dash, 100-yard dash, vertical jump, pitching speed, bench press, or other similar athletic performance tests.

A fifth step 310 may include recording the results of the athlete's performance. In one embodiment, the athlete's performance time, speed, or other result is displayed and recorded using the recording devices 140, and the athlete's actual performance is recorded using the recording devices 140. In one embodiment, the results are recorded manually or electronically by one or more individuals who are certified to obtain and record the athletic performance test results. Actual recordation of the performance results provides certification and verification that the athlete performed the requisite performance test and achieved the recorded athletic performance test results.

A sixth step 312 may include inputting the athlete information and performance test results into the host server 180. In one embodiment, the data may be input into the host server 180 manually and/or electronically via wired and/or wireless communication using a computer or other data entry device. The data may include entering the athlete's information and performance test results, as well as uploading the athlete's photos and videos of the performance test. As stated above, access to the host server 180 and the information transferred to the host server may be restricted to a primary operator to ensure that the athletic performance test data is entered correctly, and was obtained and certified using the controlled environment 100 performance test conditions.

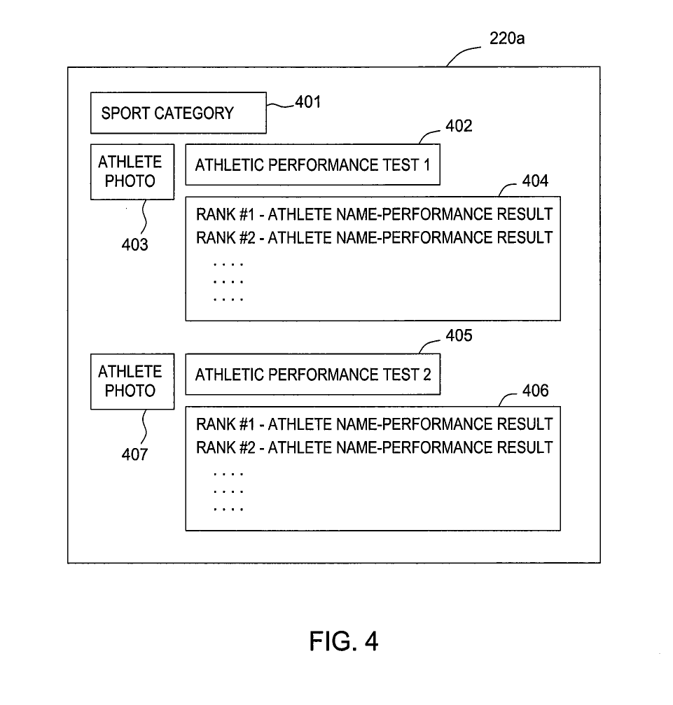

A seventh step 314 may include ranking and displaying the athlete information and performance test results of one or more athletes. The information of each athlete may be posted to the website 210 and made available over a global computer network, such as the internet, for public access. Once the data is entered into the host server 180, the data is sent through the ranking template 190 to automatically generate and post the data on the website 210 via the network server 200. In one embodiment, one or more web pages 220, as illustrated in FIGS. 4-6, may be generated to display the athletic performance data and provide a ranking of each athlete according to each specific athletic performance test by one or more performance result metrics, such as time and speed.

FIG. 4 illustrates a first web page 220a that is generated using the ranking template 190. A sports category window 401 may identify the sport associated with the respective athletic performance test performed, such as football, baseball, basketball, soccer, track, etc. An athletic performance test window 401, 405 may identify the actual performance test performed, and an athletic performance results window 404, 406 may identify the rank, athlete name, and performance result achieved of one or more athletes. An athlete photo window 403, 407 may also be displayed to identify the athlete that has achieved the highest rank or top rank of the specific performance test for the specific sport. Any one of the above windows may be displayed and arranged in a variety of ways on the first web page 220a.

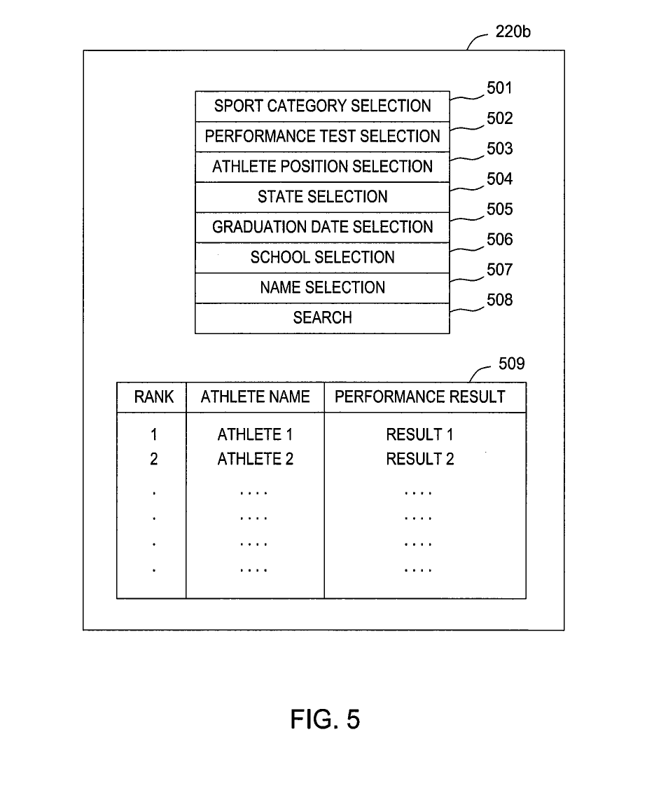

FIG. 5 illustrates a second web page 220b that is generated using the ranking template 190. The second web page 220b may include a search function to allow an individual to search for athletic performance rankings and athlete data by one or more search features. The second web page 220b may include a sports category selection window 501, a performance test selection window 502, an athlete position selection window 503, a state/country selection window 504, a graduation date selection window 505, a school selection window 506, a name selection window 507, and a search button 508. In one embodiment, the selection windows may include a pull-down or drop box feature with a listing of data to select from. In one embodiment the selection windows may include a manual entry feature, in which an individual may enter the respective data to search for. Other search categories/features may be provided to enable an individual to easily search for athlete information and performance test results as desired. Finally, a rank/results window 509 is provided to display the results of the particular search specified using the search feature. The rank/results window 509 may display the rank, athlete name, and/or performance results. Any one of the above windows may be displayed and arranged in a variety of ways on the second web page 220b.

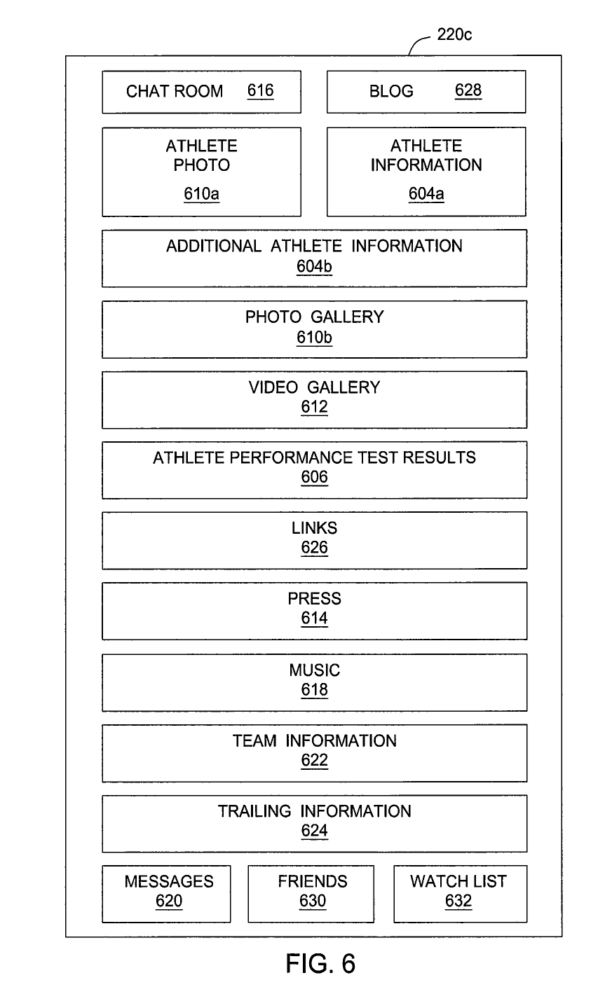

FIG. 6 illustrates a third web page 220c that may be generated using the ranking template 190. The third web page 220c may display the athlete information and performance data of an individual athlete. The third web page 220c may include a primary athlete information window 604a and a secondary athlete information window 604b that includes information about the athlete. The athlete information may include identifying/contact information entered into the host server 180 and additional information later provided by the athlete. The athlete information may include the athlete's photograph, name, gender, height, weight, school, team, primary sport, position, academic performance, grade point average, college choice, season and career goals, season and career highlights, etc.

The third web page 220c may include an athletic performance test results window 606. The athletic performance test results window 606 may display the results of all of the performance tests that the athlete performed under the controlled environment 100. In one embodiment, the information provided in the test results window 606 may only be posted and modified by the primary operator of the web site 210 to ensure that the results are certified and have not been adjusted or altered by the individual athlete.

The third web page 220c may also include a primary photo window 610a and a photo gallery window 610b for providing photographs of the athlete, a video gallery 612 for providing videos of the athlete, a press window 614 for accessing copies of press or news reports of the athlete, a chat room window 616 for communicating with other athletes who have a similar web page or other individuals who register with the website 210, a music window 618 which includes links to music of interest to the athlete, a messages window 620 which includes messages posted by visitors to the web page 220c, a team information window 622 which includes information or links relating to the athlete's team, a training information window 624 which includes one or more links to training information relating to the athlete or athlete's sport, a links window 626 which includes links to other internet sites of interest to the athlete, and a blog window 628 in which the athlete may write or blog about topics of interest. The third web page 220c may also include a friends window 630 that the athlete adds/deletes to and/or from their web page 220c to “friend” and/or befriend other athletes that have performed an athletic performance test under the controlled environment 100 and have a similar web page 220c. The friends window 630 may include a list of photos and/or information of other athletes and may provide an indication when information about the particular athlete on the friends list has been updated. The third web page 220c may also include a watch list window 632 that the athlete adds/deletes to and/or from their web page 220c to track the performances of other athletes that have performed an athletic performance test under the controlled environment 100 and have a similar web page 220c. The watch list window 632 may include a list of photos and/or information of other athletes and may provide an indication when information about the particular athlete on the watch list has been updated.

In one example, the training information window 624 may include information about the specific training that the athlete has undergone to prepare for the athletic performance test. In one example, the training information window 624 may include a training or athletic events journal that an athlete may post to display or keep track of their individual training regimen and data about recent athletic events in which they participated. Any one of the above windows may be displayed and arranged in a variety of ways on the third web page 220c.

In one embodiment, all of the data and information, results, photos, videos, links, etc. displayed on the third web page 220c may be controlled and uploaded by the primary operator of the website 210. In one embodiment, each individual athlete may be provided with access to their specific web page, such as by a password protected profile, to view, post, or modify the information displayed on the page, such as by adding text, music, photos, links, videos, training information, etc. In one embodiment, the primary operator of the website 210 may give each athlete the ability to modify their data and personal information except for the certified performance results and actual recording of the performance test. In one embodiment, one or more of the window on the third web page 220c may be viewable and/or editable only by the primary operator of the website 210, the individual athlete, and/or other individuals accessing the website 210.

In one embodiment, the website 210 may include a registration web page that an athlete may access to register with the website to enter information about themselves for access and display on the third web page 220c. In one embodiment, only athletes that have performed an athletic performance test under the controlled environment 100 conditions may be allowed to register. In one embodiment, the primary operator of the website 210 may provide athletes who have performed a test under the controlled environment 100 conditions and/or other individuals a password to register and access information on the third web page 220c. In one embodiment, each web page 220c may be posted to the website 210 in a private mode accessible only by the primary operator of the website 210 and the athlete, and/or in a public mode accessible by generally anyone accessing the website. In one embodiment, any of the information displayed on the web pages 220a, 220b, 220c may provide a link to one of the other web pages for quick reference.

In one embodiment, the third web page 220c may include the same information about a specific team and/or school rather than an individual athlete. The third web page 220c may include similar data about all of the athletes that are associated with the team and/or school, and may further include links to web pages on the web site 210 about the individual athletes on the team and/or school as described above. In one embodiment, the messages window 620 may be controlled by the primary operator of the website 210 to open and close timeframes during which the athlete may send and/or receive messages to and from coaches and/or recruiters. In one embodiment, the primary operator of the website 210 may enable and disable the messages window 620 based upon athletic regulatory agency rules, such as the University Interscholastic League and the National Collegiate Athletic Association, that regulate when an athlete may communicate with a coach and/or recruiter. In one embodiment, the messages window 620 may be privately viewed by the athlete and may not be publicly viewable by other individuals accessing the website 210 to protect the privacy and confidentiality of any communications between an athlete and/or coach and recruiter.

In one embodiment, the website 210 may be searchable by users to access and display athlete rankings and information as desired. In this manner, athletes, recruiters, coaches, and/or any other individuals can view and compare how an athlete ranks relative to other athletes on a local, state, national, and global basis under controlled environment athletic performance test conditions with certified and verified athletic performance test results.

While the foregoing is directed to embodiments of the invention, other and further embodiments of the invention may be devised without departing from the basic scope thereof, and the scope thereof is determined by the claims that follow.

1. An athletic performance testing system, comprising:
a controlled athletic performance testing environment including a portable surface, a sensing device, a recording device, and a display device;
a host server for receiving athletic performance test data obtained using the controlled environment; and
a website for displaying the athletic performance test data and including a web page for displaying the rankings of the athletic performance test data.

2. The system of claim 1, wherein the portable surface includes artificial turf, wherein the sensing device includes one or more laser-switch type sensor, wherein the recording device includes one or more video cameras, and wherein the displaying devices includes a timer and time display.

3. The system of claim 2, wherein the sensors are positioned at first and second ends of the portable turf and are in communication with a controller for activating the timer upon actuation of the sensors by an athlete, and wherein the video cameras are arranged to simultaneously record the athlete moving across the portable turf from the first end to the second end and the time display.

4. The system of claim 1, wherein the portable turf include a pitching mound, wherein the sensing device include a radar gun, wherein the recording device includes a video camera, and wherein the displaying device includes a speed display.

5. The system of claim 1, further comprising a ranking template for automatically ranking the athletic performance test data for display on the website.

6. The system of claim 1, wherein the website further comprises one or more web pages for displaying the athletic performance test data.

7. The system of claim 6, wherein a first web page includes an athletic performance test window, an athletic performance test results window that includes a ranking of athletic performances, and a photo of an athlete that has the highest ranked performance test results.

8. The system of claim 6, wherein a second web page includes a search feature for searching athletic performance test results and athlete information by one or more of a sport category, a performance test category, an athlete position category, a state/country category, a graduation date category, a school category, and an athlete name category.

9. The system of claim 8, wherein the second web page includes a rank/results window for displaying search results retrieved using the search feature, the search results including at least a rank of an athlete, the athletes name, and a performance result of the athlete.

10. The system of claim 6, wherein a third web page includes information relating to an individual athlete including an athlete information window and a performance test results window, wherein the athlete information window is accessible by the individual athlete, wherein the performance test results window is accessible only by an operator of the website.

11. The system of claim 10, wherein the third web page further includes at least one of an athlete photos window, a videos window, a press window, a chat room window, a team information window, a music window, a training information window, a messages window, a links window, and a blog window.

12. A method of ranking athletic performance test data, comprising:
obtaining information about an athlete;
setting up a controlled athletic performance testing environment;
verifying that the controlled athletic performance testing environment is in accordance with a certified testing standard;
recording the athletic performance of the athlete performing under the controlled athletic performance testing environment;
inputting the athlete information and athletic performance test results of the athlete into a host server; and
providing a website to display the athletic performance test results, wherein athletes are automatically ranked according to their athletic performance test results under the controlled athletic performance testing environment.

13. The method of claim 12, further comprising obtaining information about one or more athletes including at least one of name, age, gender, weight, height, school, sport, and position.

14. The method of claim 12, wherein the controlled athletic performance testing environment includes a portable turf, a sensing device, a recording device, and a timing device, and further comprising sensing the start and finish of an athletic performance by the athlete using the sensing device, and recording and timing the athlete's performance as the athlete moves from one end of the portable turf to the opposite end using the recording and timing devices, respectively.

15. The method of claim 14, further comprising moving the controlled athletic performance testing environment from a first location to a second location, recording athletic performance test results of athletes performing under the controlled athletic performance testing environment at the first location and the second location, and ranking the athletic performance test results of the athletes.

16. The method of claim 15, further comprising certifying that the controlled athletic performance testing environment conditions are the same at the first location and the second location.

17. The method of claim 12, further comprising providing the athlete with access to the website to modify and add information about the athlete.

18. The method of claim 12, further comprising restricting the athlete from modifying the athletic performance test results.

19. The method of claim 12, further comprising enabling and disabling a messaging window to allow the athlete to communicate with coaches and recruiters according to athletic regulatory agency rules.

20. The method of claim 12, wherein the athletic performance test results includes a video recording of the athlete's performance under the controlled athletic performance testing environment.

21. A method of ranking athletic performance test data, comprising:
obtaining information about an athlete;
setting up a controlled athletic performance testing environment;
verifying that the controlled athletic performance testing environment is in accordance with a certified testing standard;
recording the athletic performance of the athlete performing under the controlled athletic performance testing environment;
inputting the athlete information and athletic performance test results of the athlete into a host server; and
causing the athletic performance test results to be displayed on a website, wherein athletes are automatically ranked according to their athletic performance test results under the controlled athletic performance testing environment.
